(19) United States
(12) Patent Application Publication
(10) Pub. No.: US 2017/0309187 A1
(43) Pub. Date: Oct. 26, 2017

(54) VEHICLE PLATOON SYSTEM AND METHOD THEREOF

(71) Applicant: Hsin-Nan LIN, New Taipei City (TW)

(72) Inventor: Hsin-Nan LIN, New Taipei City (TW)

(21) Appl. No.: 15/136,026

(22) Filed: Apr. 22, 2016

(51) Int. Cl. G08G 1/00; B60W 30/16

(52) U.S. Cl. CPC G08G 1/22; B60W 30/16

(57) ABSTRACT

A vehicle platoon system comprises a trajectory module, an operation module and a control module. The trajectory module obtains and records a first data from a driving condition of the leading vehicle to establish a movement trajectory. The operation module obtains a second data and receives the first data to enable the following vehicle to move along or on the movement trajectory and carry out the driving condition of the leading vehicle. The control module measures an interval distance between the leading vehicle and the following vehicle to adjust a speed of at least one of the leading vehicle and the following vehicle so as to maintain the interval distance within a predetermined range. A vehicle platooning method is also provided.

### BACKGROUND OF THE INVENTION

### 1. Field of the Invention

The present invention relates to the field of intelligent driving and more particularly to a vehicle platoon system and a method thereof allowing flexible and safe coupling of a plurality of transportation vehicles.

### 2. Description of Related Art

Conventionally, public transportation vehicles, such as electric multiple units, buses, and automobiles, provide transportation capacity to transport people and goods.

For example, buses provide fixed transportation capacity and require a driver. Due to the fixed transportation capacity, insufficient transportation capacity problems arise during rush hours and traffic congestion. To address this issue, conventionally the number and size of buses, dispatch frequency and drivers are increased. However, this approach inevitably increases the investment and labour costs. In particular, during off-peak hours, idle vehicles and redundant dispatches aggravate the waste of transportation costs.

With the surge of environmental awareness, many diesel-driven buses are changed to more eco-friendly electric-driven buses, hereinafter “electric vehicles.” Although electric vehicles meet the requirements of environmental protection, they disadvantageously cause other problems. For example, since the power of electric vehicles comes from batteries, their weight will increase after installation of batteries, resulting in a substantial reduction of loading capacity when compared with diesel-driven buses. In addition, the higher price of electric vehicles further increases the risk mentioned above. Conventionally, to solve the problems of transportation capacity of buses and electric vehicles, towing vehicles and autonomous vehicles have also been proposed to increase the flexibility of transportation capacity, in addition to increasing the size of buses and electric vehicles.

However, these approaches have their own limitations. For example, with the increase of number of towing carriages, the difference within individual tracks increases, which causes potential safety hazard for road traffic. Other the other hand, there are generally two categories of autonomous vehicles. The first one involves large infrastructure investments, such as burying magnets underground or setting up ground-based GPS reference stations, so as to determine the position of autonomous vehicles with high precision. The second one involves using expensive high precision sensors, such as lidar devices and high precision maps which require frequent update. Accordingly, these technologies face many problems in real-world applications, both in terms of high costs and technological bottleneck, and these problems need to be tackled in advance before they can be implemented in commercial operation.

In view of the foregoing, this invention provides a vehicle platoon system and a method thereof to address the drawbacks of the conventional technologies.

### SUMMARY OF THE INVENTION

A first object of this invention is to provide a vehicle platoon system using a trajectory module, an operation module and a control module to enable virtual coupling of a leading vehicle, also known as a preceding vehicle or a front unit, and a following vehicle, also known as a following unit, so as to minimize the number of drivers required for transportation of people and goods.

Based on the aforesaid vehicle platoon system, a second object of this invention is to allow flexible coupling of the leading vehicle according to actual transportation capacity with one or more following vehicles to reduce transportation costs.

Based on the aforesaid vehicle platoon system, a third object of this invention is to enable the following vehicle to reproduce, replicate or carry out the driving condition(s) of the leading vehicle, such as electric throttle state, turning angle, and advancing direction, on the movement trajectory to achieve the purpose of safe transportation.

Based on the aforesaid vehicle platoon system, a fourth object of this invention is to change the speed of the leading vehicle, the following vehicle or both, thereby maintaining a predetermined range of distance between the leading vehicle and the following vehicle so as to ensure high stability and safety during the movement of the vehicles.

Based on the aforesaid vehicle platoon system, a fifth object of this invention is to allow the following vehicle to perform further adjustment during reproducing the first driving condition of the leading vehicle such that the following vehicle may move with the use of a second driving condition.

Based on the aforesaid vehicle platoon system, a sixth object of this invention is to establish a transmission path between the leading vehicle and the following vehicle via a connection module for transmitting data, power or both.

Based on the aforesaid vehicle platoon system, a seventh object of this invention is to further analyze the image features, such as image size, of the leading vehicle to determine the relative position of the leading vehicle and the following vehicle. In other words, this system can set up a determination mechanism for visual positioning according to the image features, without having to relying on a high precision positioning system, such as a differential global positioning system (DGPS), thereby solving the problem of positioning failure of the positioning system incapable of receiving satellite signals and the problem of complicated computation required for precise positioning.

Based on the aforesaid vehicle platoon system, an eighth object of this invention is to perform coupling movement of a plurality of vehicles, such a leading vehicle coupled with a plurality of following vehicles, whereby any one of the aforesaid purposes and objects can be realized between the leading vehicle and following vehicles and between different following vehicles.

A ninth object of this invention is to provide a vehicle platooning method enabling the following vehicle to follow the leading vehicle safely and carry out the driving condition of the leading vehicle.

To achieve the above-mentioned and other objects, this invention provides a vehicle platoon system, which comprises a trajectory module, an operation module and a control module. The trajectory module is arranged at the leading vehicle. The trajectory module obtains and records a plurality of first position data and driving data from the driving condition of the leading vehicle. The trajectory module establishes a movement trajectory according to the first position data, wherein the first position data and the driving data constitute a first data. The operation module is arranged at the following vehicle. The operation module obtains a second data and receives the first data. The operation module drives the following vehicle according to the second data so as to enable the following vehicle to move along or on the movement trajectory. Moreover, the operation module, according to the first data, operates the following vehicle to enable the following vehicle to carry out the driving condition of the leading vehicle on the movement trajectory, wherein the second data is associated with a direction of and a distance between the leading vehicle and the following vehicle. The control module is disposed at at least one of the leading vehicle and the following vehicle. The control module measures the interval distance between the leading vehicle and the following vehicle. Also, the control module adjusts a speed of at least one of the leading vehicle and the following vehicle so as to maintain the interval distance within a predetermined range.

To achieve the above-mentioned and other objects, this invention provides a vehicle platooning method, comprising the following steps: (a) according to a driving condition of a leading vehicle, obtaining a plurality of first position data and a driving data of the leading vehicle to form a first data, and establishing a movement trajectory according to the first position data; (b) obtaining a second data from a following vehicle which is associated with a relative position of the leading vehicle and the following vehicle; (c) processing the first data and the second data to drive the following vehicle to move along or on the movement trajectory; (d) the following vehicle carrying out the driving condition of the leading vehicle on the movement trajectory according to the first data; and (e) determining an interval distance between the leading vehicle and the following vehicle so as to adjust a speed of the following vehicle based on the first data so as to maintain the interval distance within a predetermined range.

Compared with other existing technologies, the vehicle platoon system and the method thereof according to the present invention can safely couple the leading vehicle and the following vehicle within a predetermined range. This invention obtains and records the driving condition, such as position data and driving data, of the leading vehicle on the movement trajectory, to allow the following vehicle to carry out the driving condition of the leading vehicle on the movement trajectory, such as to allow the following vehicle to perform the driving condition at a specific position of the leading vehicle at that specific position.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a block diagram according to a first embodiment of the vehicle platoon system of this invention;

FIG. 2 illustrates a status list of the vehicle platoon system of FIG. 1;

FIG. 3 illustrates a movement trajectory of the vehicle platoon system of FIG. 1;

FIG. 4 illustrates the formation process of the second data of the operation module of FIG. 1;

FIG. 5 illustrates the control of interval distance by the control module of FIG. 1;

FIG. 6 illustrates a detailed block diagram of the trajectory module of FIG. 1;

FIG. 7 illustrates a detailed block diagram of the operation module of FIG. 1;

FIG. 8 illustrates the relationship of the following vehicle and the movement trajectory according to the vehicle platoon system of FIG. 1;

FIG. 9 illustrates a control process of the operation module of FIG. 7;

FIG. 10 illustrates a detailed block diagram of the control module of FIG. 1;

FIG. 11 illustrates a block diagram according to a second embodiment of the vehicle platoon system of this invention; and

FIG. 12 illustrates a flowchart of a vehicle platooning method according to an embodiment of this invention.

### DESCRIPTION OF THE EMBODIMENTS

Embodiments are illustrated in the accompanying figures to improve understanding of concepts as presented herein. Skilled artisans appreciate that elements in the figures are illustrated for simplicity and clarity and have not necessarily been drawn to scale. As used herein, the term in “platoon” or “platooning” refers to grouping vehicles to increase the capacity of roads, such as by electronic and/or mechanical coupling of vehicles to allow them to accelerate or brake simultaneously or in a controlled manner. As used herein, terms “leading vehicle”, “preceding vehicle” and “front unit” are used interchangeably to refer to and encompass a vehicle in front of at least one other vehicle in a group of vehicles or platoon. As used herein, terms “following vehicle” and “following unit” are used interchangeably to refer to and encompass a vehicle behind at least one other vehicle in a group of vehicles or platoon.

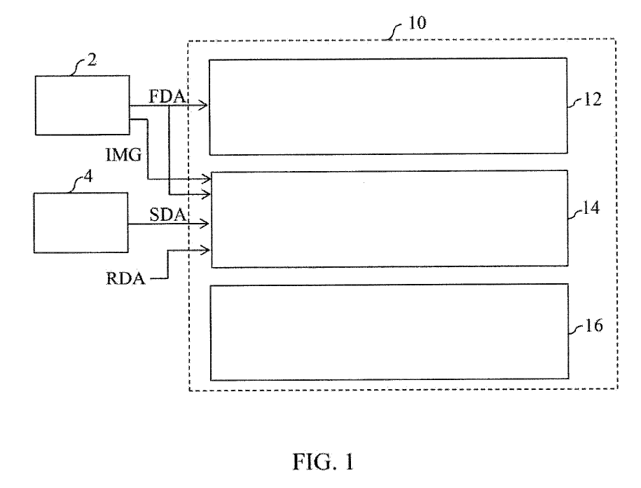

FIG. 1 illustrates a block diagram according to a first embodiment of the vehicle platoon system of this invention. The vehicle platoon system 10 enables coupling operation and movement of a leading (i.e. preceding) vehicle 2 and a following vehicle 4, wherein the leading vehicle 2 and the following vehicle 4 may independently be an electric multiple unit, a bus or an automobile. In this embodiment, electric-driven buses are used as the example for the leading vehicle 2 and the following vehicle 4.

The vehicle platoon system 10 comprises a trajectory module 12, an operation module 14 and a control module 16.

The trajectory module 12 is disposed at the leading vehicle 2 for processing a driving condition of the leading vehicle 2, wherein the driving condition may be for example a coordinate position (e.g. latitude, longitude and elevation), mileage, travelling distance, speed, heading direction (also known as pose or driving direction of a vehicle), and/or steer angle of the leading vehicle 2. For the purpose of brevity, the aforesaid mileage, travelling distance, speed, heading direction and steer angle are collectively referred to as driving data. In this embodiment, the trajectory module 12 obtains and records first position data, heading direction and steer angle from the driving condition, wherein the first position data and the driving data constitute a first data FDA.

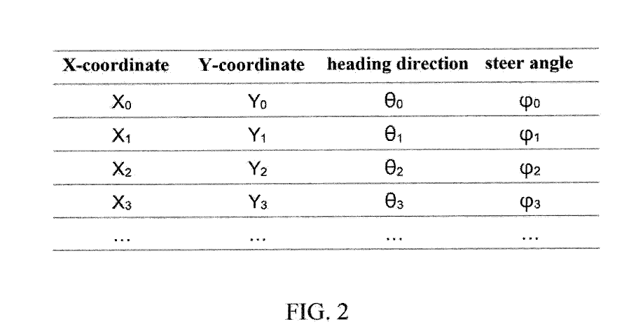

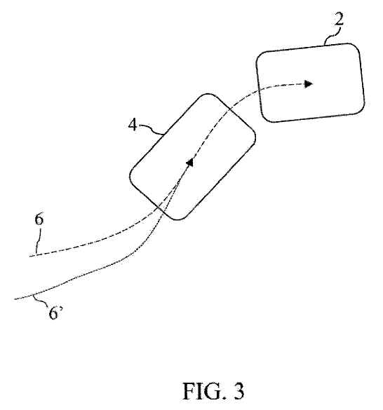

Refer to FIG. 2, which tabulates the driving condition as a status list. The status list provides four columns, which are X-coordinate, Y-coordinate, heading direction θ and steer angle φ, for representing the first position data and the driving data. During the movement of the leading vehicle 2, the driving condition is continuously recorded into the status list. In this embodiment, the driving condition is recorded in real time, but in other embodiments, the trajectory module 12 may start obtaining and recording the driving condition only when other criteria are met. For example, the trajectory module 12 may determines the speed of the leading vehicle 2 in advance, and as long as the speed is not 0 km/hr, the trajectory module 12 will record the driving condition into the status list. In addition, the trajectory module 12 may, according to the X-coordinate and Y-coordinate of the status list in FIG. 2, establish a movement trajectory 6, which is illustrated in FIG. 3. As shown in FIG. 3, the movement trajectory 6 represents the movement trajectory of the leading vehicle 2, and the movement trajectory 6′ represents the movement trajectory of the following vehicle 4.

Refer back to FIG. 1. The operation module 14 is disposed at the following vehicle 4 for obtaining a second data SDA and receiving the first data FDA. After the data FDA and SDA are obtained and received, the operation module 14 primarily serves the following two functions. First, the operation module 14 drives the following vehicle 4 with the second data SDA so as to enable the following vehicle 4 to move along or on the movement trajectory 6, wherein the second data SDA is associated with a direction of and a distance between the leading vehicle 2 and the following vehicle 4. Second, the operation module 14, in accordance with the first data FDA, operates the following vehicle 4 to enable the following vehicle 4 to carry out the driving condition of the leading vehicle 2 on the movement trajectory 6.

More specifically, the second data SDA may be formed by predefining a reference image of the leading vehicle 2, such as the image of vehicle appearance, shape of the back portion, pattern, text, or license plate, in which vehicle appearance is used as the example in the following description of this embodiment, and then the reference image is saved as data in the trajectory module 12, the operation module 14 or both. Therefore, a reference data RDA corresponding to the reference image is saved in the trajectory module 12, the operation module 14 or both. In this embodiment, the reference data RDA saved in the operation module 14 is used as an example. After that, the operation module 14 captures the image IMG of the leading vehicle 2 and analyzes the image IMG to form an image data IDA. The operation module 14 compares the image data IDA and the reference data RDA to form the second data SDA.

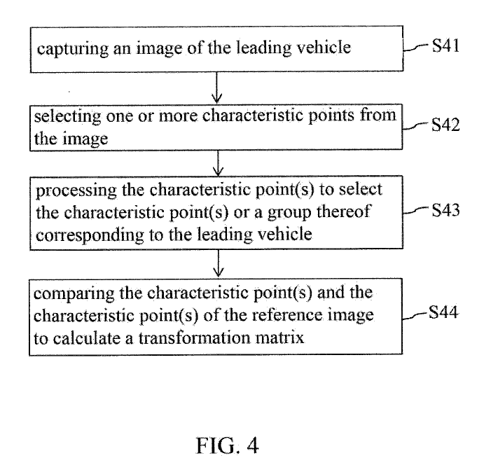

Refer also to FIG. 4, which illustrates the formation process of the second data by the operation module of FIG. 1. As shown in FIG. 4, step S41 involves the following vehicle 4 using a camera (not shown) for example to capture the image IMG of the leading vehicle 2; step S42 involves selecting one or more characteristic points from the image IMG; step S43 involves processing the characteristic point(s) to select the characteristic point(s) or a group thereof corresponding to the leading vehicle 2; and step S44 involves comparing the characteristic point(s) and the characteristic point(s) of the reference image to calculate a transformation matrix which may include rotation and translation for example. With all relations within units, the transformation matrix can be employed for calculating the relative position of the leading vehicle 2 and the following vehicle 4.

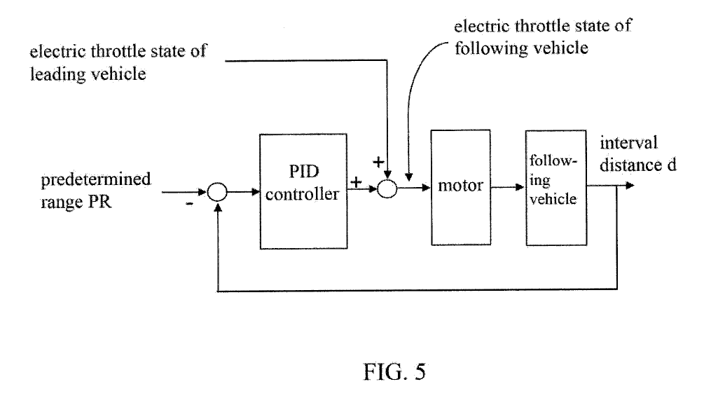

Refer back to FIG. 1. The control module 16 is disposed at the leading vehicle 2, the following vehicle 4 or both. The control module 16 controls an interval distance d between the leading vehicle 2 and the following vehicle 4. Refer also to FIG. 5, which illustrates the control of the interval distance by the control module of FIG. 1. As illustrated in this example, the control module 16 is arranged at the following vehicle 4, and according to a predetermined range PR preset in advance, the control module 16 maintains the interval distance d between the leading vehicle 2 and the following vehicle 4 within the predetermined range PR. From the left of FIG. 5, the control module 16 calculates the difference between the interval distance d and the predetermined range PR, so as to determine whether the interval distance d between the leading vehicle 2 and the following vehicle 4 falls within the predetermined range PR. Then the difference is outputted to a proportional-integral-derivative controller (PID controller) and further processed together with the electric throttle state of the leading vehicle 2 to control or adjust the electric throttle command of the following vehicle 4, thereby changing the interval distance d by controlling the traction motor of the following vehicle 4. Finally, the interval distance d is feedbacked to the left side again and processed together with the predetermined range PR.

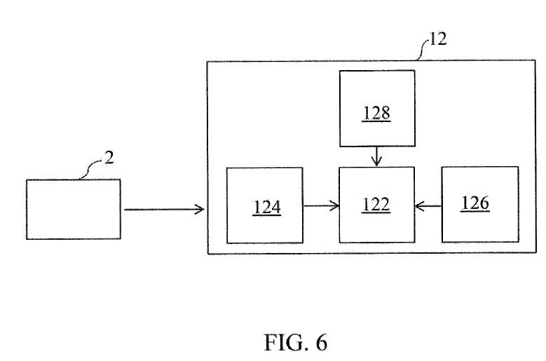

FIG. 6 illustrates a detailed block diagram of the trajectory module of FIG. 1, in which the trajectory module 12 comprises a first processing unit 122, a first direction unit 124, a first distance measurement unit 126 and a first recording unit 128.

The first processing unit 122 is connected with the first direction unit 124, the first distance measurement unit 126 and the first recording unit 128. The first processing unit 122 controls, analyzes, processes, and stores the data outputted from the first direction unit 124, the first distance measurement unit 126 and the first recording unit 128.

The first direction unit 124 obtains a first direction data, which records the heading direction (e.g. pose) of the leading vehicle 2, and the heading direction can be defined as a direction longitudinally extended from the front portion of the leading vehicle 2.

The first distance measurement unit 126 obtains a first distance data, which records the travelling distance of the leading vehicle 2. For example, the first distance measurement unit 126 may be a wheel encoder, a global positioning system and/or a visual odometry device.

The first processing unit 122 processes the first direction data and the first distance data to further obtain the first position data of FIG. 1.

The first recording unit 128 obtains the driving data, which can be extracted from the electronic control unit (ECU) of the leading vehicle 2, wherein the electronic control unit records such as mileage, travelling distance, speed, heading direction and steer angle, and wherein the steer angle is associated to the operation of the steering wheel of the leading vehicle 2.

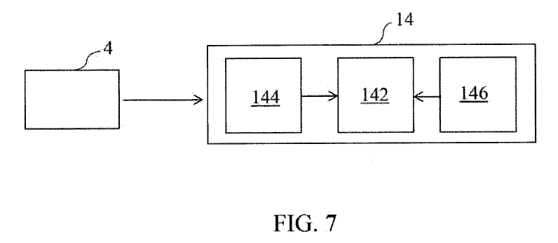

FIG. 7 illustrates a detailed block diagram of the operation module of FIG. 1. As shown in FIG. 7, the operation module 14 comprises a second processing unit 142, a second direction unit 144 and a second distance measurement unit 146. In this embodiment, the operation module 14, compared with the trajectory module 12, does not need a recording unit, but in other embodiments, the operation module 14 may further comprise a second recording unit (not shown).

The second processing unit 142 is connected with the second direction unit 144 and the second distance measurement unit 146. The second processing unit 142 controls, analyzes, processes and stores the data outputted from the second direction unit 144 and the second distance measurement unit 146.

The second direction unit 144 obtains a second direction data, which records the heading direction (e.g. pose) of the following vehicle 4, and the heading direction can be defined as a direction longitudinally extended from the front portion of the following vehicle 4.

The second distance measurement unit 146 obtains a second distance data, which records the travelling distance of the following vehicle 4. For example, the second distance measurement unit 146 may be a wheel encoder, a global positioning system and/or a visual odometry device.

The second processing unit 142 processes the second direction data, the second distance data and the first data FDA to allow the following vehicle 4 to perform tracking and operating actions.

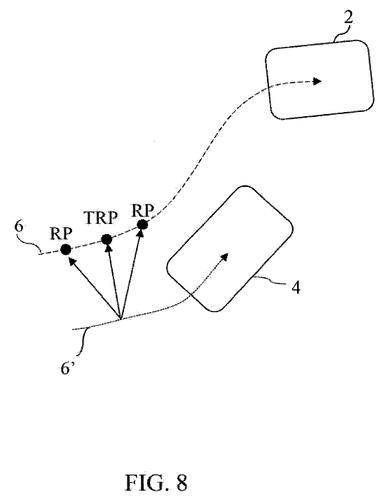

For example, during the tracking action, taken in conjunction with FIG. 8, the second processing unit 142 selects a trajectory reference point TRP from a plurality of reference points RP of the movement trajectory 6, such that the distance between the reference points RP other than the trajectory reference point TRP and the following vehicle 4 is greater than or equal to the distance between the following vehicle 4 and the trajectory reference point TRP. The second processing unit 142 calculates the distance between the following vehicle 4 and the trajectory reference point TRP so as to obtain the second distance data and the second direction data. According to the second distance data and the second direction data, the following vehicle 4 may move along or on the movement trajectory 6.

During the operating action, the second processing unit 142 may, according to the second distance data and the second direction data, such as the data in each box of the status list shown in FIG. 2, further enable the following vehicle 4 to carry out the driving condition of the leading vehicle 2 on the movement trajectory 6. In particular, when the following vehicle 4 moves to the X-coordinate and Y-coordinate as shown in the status list, the second processing unit 142 may control the following vehicle 4 according to the heading direction and the steer angle corresponding to the X-coordinate and Y-coordinate, such that the following vehicle 4 adopts the heading direction and the steer angle of the leading vehicle 2 at the X-coordinate and Y-coordinate corresponding to the X-coordinate and Y-coordinate.

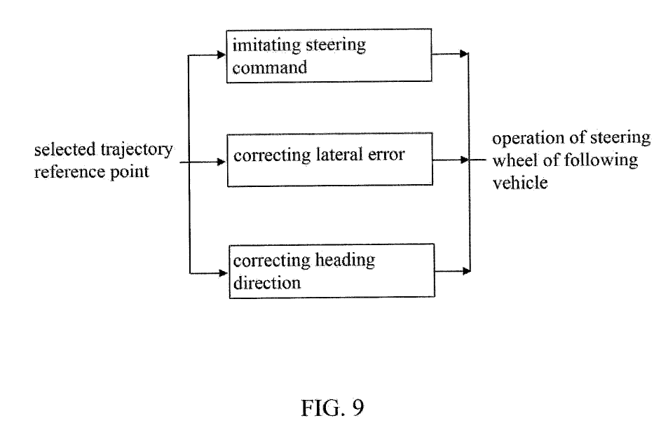

It should be noted that, although the second processing unit 142 enables the following vehicle 4 to carry out the driving condition of the leading vehicle 2 on the movement trajectory 6, the second processing unit 142 can still adjust the driving condition of the following vehicle 4 within an adjustment range based on the first data FDA. In another embodiment, taken in conjunction with FIG. 9, a control process of the operation module of FIG. 7 is illustrated. From the left, after the second processing unit 142 selects the trajectory reference point TRP, the second processing unit 142 calculates a plurality of parameters to determine how to operate and control the steering wheel of the following vehicle 4 practically, wherein the parameters comprise imitating reference points (i.e. the heading direction and the steer angle at the trajectory reference point TRP of the status list), correcting lateral error (i.e. the difference between the following vehicle 4 and the trajectory reference point TRP on the movement trajectory 6 of the leading vehicle 2) and correcting the heading direction. Therefore, the operation of the steering wheel of the following vehicle 4 and the operation of the steering wheel of the leading vehicle 2 at the same trajectory point may not be the same. In other words, at the same trajectory point, the following vehicle 4 primarily imitates the operation of the steering wheel of the leading vehicle 2, and the second processing unit 142 further adjusts the operation of the steering wheel of the following vehicle 4 according to other parameters.

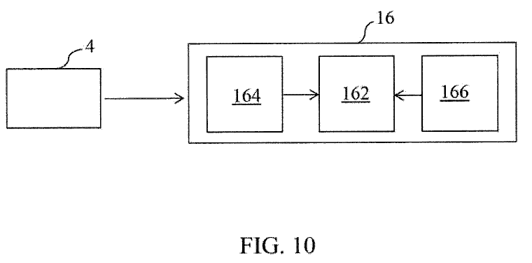

FIG. 10 illustrates a detailed block diagram of the control module of FIG. 1, wherein the control module 16 comprises a third processing unit 162, a third distance measurement unit 164 and a third speed control unit 166.

The third processing unit 162 is connected with the third distance measurement unit 164 and the third speed control unit 166. The third processing unit 162 controls, analyzes, processes, and stores the data outputted from the third distance measurement unit 164 and the third speed control unit 166.

The third distance measurement unit 164 measures the interval distance d in FIG. 5. The third distance measurement unit 164, which may be a visual odometry device, can calculate the relative position of the leading vehicle 2 and the following vehicle 4 according to the size variation between the reference image and the image IMG.

The third processing unit 162 drives the third speed control unit 166 to adjust the speed of the following vehicle 4. For example, the third speed control unit 166 may control the output of the traction motor and/or engine of the following vehicle 4 to adjust its speed.

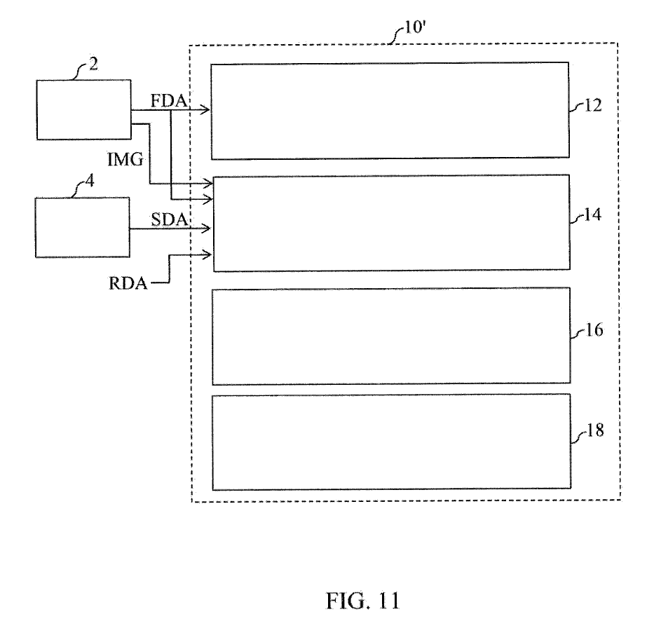

FIG. 11 illustrates a block diagram according to a second embodiment of the vehicle platoon system of this invention. In this embodiment, the vehicle platoon system 10′ comprises a connection module 18 in addition to the trajectory module 12, the operation module 14 and the control module 16 as illustrated in the first embodiment.

The connection module 18 may be disposed at the leading vehicle 2, the following vehicle 4 or both and is useful for establishing a transmission path between the leading vehicle 2 and the following vehicle 4 for transmitting data, power or both. In this embodiment, the connection module 18 enables power transmission between the leading vehicle 2 and the following vehicle 4 so as to perform power distribution and management. For example, the following vehicle 4 may transfer its power to the leading vehicle 2.

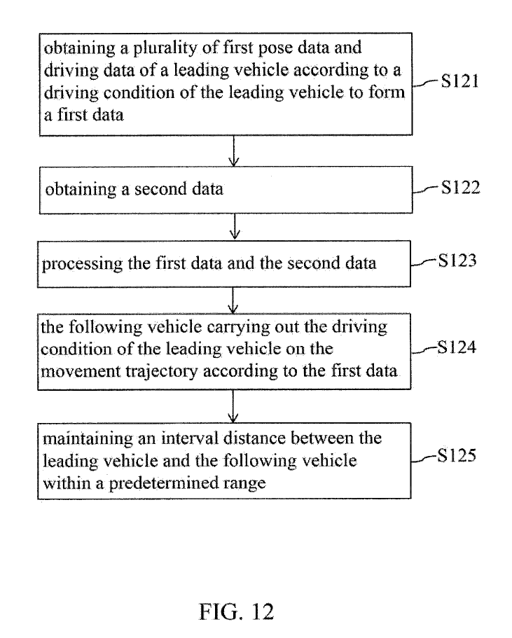

FIG. 12 illustrates a flowchart of a vehicle platooning method according to an embodiment of this invention. The vehicle platooning method comprises step S121: obtaining a plurality of first pose data (i.e. data associated to position and heading) and a driving data of a leading vehicle to form a first data according to a driving condition of the leading vehicle, and establishing a movement trajectory according to the first position data;

step S122: obtaining a second data which is associated with a relative position of the leading vehicle and the following vehicle;

step S123: processing the first data and the second data to drive the following vehicle to move along or on the movement trajectory;

step S124: the following vehicle carrying out the driving condition of the leading vehicle on the movement trajectory according to the first data; in another embodiment, the method further comprises adjusting the driving condition of the following vehicle within an adjustment range based on the first data;

step S125: determining an interval distance between the leading vehicle and the following vehicle so as to adjust a speed of the following vehicle based on the first data to maintain the interval distance within a predetermined range.

The above detailed description is merely illustrative in nature and is not intended to limit the embodiments of the subject matter or the application and uses of such embodiments. Moreover, while at least one exemplary embodiment has been presented in the foregoing detailed description, it should be appreciated that a vast number of variations exist. It should also be appreciated that the exemplary one or more embodiments described herein are not intended to limit the scope, applicability, or configuration of the claimed subject matter in any way. Rather, the foregoing detailed description will provide those skilled in the art with a convenient guide for implementing the described one or more embodiments. Also, various changes can be made in the function and arrangement of elements without departing from the scope defined by the claims, which include known equivalents and foreseeable equivalents at the time of filing this patent application.

What is claimed is:

1. A vehicle platoon system, comprising:
a trajectory module disposed at a leading vehicle for obtaining and recording a plurality of first position data and a driving data from a driving condition of the leading vehicle to establish a movement trajectory according to the first position data, wherein the first position data and the driving data constitute a first data;
an operation module disposed at a following vehicle for obtaining a second data and receiving the first data, the operation module driving the following vehicle with the second data to enable the following vehicle to move along or on the movement trajectory, the operation module operating the following vehicle according to the first data to enable the following vehicle to carry out the driving condition of the leading vehicle on the movement trajectory, wherein the second data is associated with a direction of and a distance between the leading vehicle and the following vehicle; and
a control module disposed at at least one of the leading vehicle and the following vehicle, the control module measuring an interval distance between the leading vehicle and the following vehicle and adjusting a speed of at least one of the leading vehicle and the following vehicle so as to maintain the interval distance within a predetermined range.

2. The vehicle platoon system of claim 1, wherein the trajectory module comprises a first processing unit, a first direction unit, a first distance measurement unit and a first recording unit, the first processing unit being connected with the first direction unit, the first distance measurement unit and the first recording unit, the first direction unit obtaining a first direction data, the first distance measurement unit obtaining a first distance data, the first recording unit obtaining the driving data, the first processing unit forming the first position data from the first direction data and the first distance data.

3. The vehicle platoon system of claim 1, wherein the operation module comprises a second processing unit, a second direction unit and a second distance measurement unit, the second processing unit being connected with the second direction unit and the second distance measurement unit, the second direction unit obtaining a second direction data, the second distance measurement unit obtaining a second distance data, the second processing unit processing the second direction data, the second distance data and the first data to enable the following vehicle to move along or on the movement trajectory and carry out the driving condition of the leading vehicle on the movement trajectory.

4. The vehicle platoon system of claim 3, wherein the second processing unit selects a trajectory reference point from a plurality of reference points of the movement trajectory and calculating a distance between the following vehicle and the trajectory reference point so as to obtain the second distance data and the second direction data.

5. The vehicle platoon system of claim 4, wherein a distance between the following vehicle and the reference points other than the trajectory reference point is not less than a distance between the following vehicle and the trajectory reference point.

6. The vehicle platoon system of claim 1, wherein the operation module further adjusts a driving condition of the following vehicle within an adjustment range based on the first data.

7. The vehicle platoon system of claim 1, wherein the control module comprises a third processing unit, a third distance measurement unit and a third speed control unit, the third processing unit being connected with the third distance measurement unit and the third speed control unit, the third distance measurement unit measuring the interval distance, and the third processing unit driving the third speed control unit to control the speed of the following vehicle.

8. The vehicle platoon system of claim 1, wherein the operation module captures an image of the leading vehicle, the operation module or the trajectory module analyzes the image to form an image data, and the operation module or the trajectory module compares the image data with a reference data to form the second data.

9. The vehicle platoon system of claim 1, further comprising a connection module configured between the leading vehicle and the following vehicle for establishing a transmission path therebetween for transmission of data, power or both.

10. A vehicle platooning method, comprising:
(a) according to a driving condition of a leading vehicle, obtaining a plurality of first position data and a driving data of the leading vehicle to form a first data, and establishing a movement trajectory according to the first position data;
(b) obtaining a second data which is associated with a relative position of the leading vehicle and a following vehicle;
(c) processing the first data and the second data to drive the following vehicle to move along or on the movement trajectory;
(d) the following vehicle carrying out the driving condition of the leading vehicle on the movement trajectory according to the first data; and
(e) determining an interval distance between the leading vehicle and the following vehicle so as to adjust a speed of the following vehicle based on the first data so as to maintain the interval distance within a predetermined range.

11. The vehicle platooning method of claim 10, further comprising, in step (d), adjusting a driving condition of the following vehicle within an adjustment range based on the first data.
